(19) United States
(12) Patent Application Publication
(10) Pub. No.: US 2004/0139355 A1
(43) Pub. Date: Jul. 15, 2004

(54) Method and system of accessing a plurality of network elements

(76) Inventors: David J. Axel, Winter Springs, FL (US); Navin Gupta, Lake Mary, FL (US); Kenneth Harris, Saint Cloud, FL (US)

Correspondence Address: Siemens Corporation, Intellectual Property Department, 170 Wood Avenue South, Iselin, NJ, 08830, US

(21) Appl. No.: 10/704,269

(22) Filed: Nov. 7, 2003

Related U.S. Application Data
(60) Provisional application No. 60/424,504, filed on Nov. 7, 2002.

(51) Int. Cl. H04L 9/32

(52) U.S. Cl. 713/202

(57) ABSTRACT

A method of accessing a plurality of network elements (NE) with at least one network element management program (NEMP) running on at least one element manager (EM) comprises the steps of capturing a username and a password within said network element management program (NEMP) and submitting said captured username and password to each of said plurality of network elements (NE) so as to effect administrative address privileges for each of said plurality of network elements (NE) without re-capturing said username and said password.

The purpose of the method is to capture the username and password of the user in order to log the user into individual network elements (NE) without having to reenter his username and password.

### PRIORITY OF INVENTION

The instant application claims priority to the U.S. Provisional Application, Serial No. 60/424,504, filed Nov. 7, 2002, entitled ‘Method and Apparatus For Accessing Network Elements’ the contents of which is incorporated in its entirety herein.

### BACKGROUND

### FIELD OF THE INVENTION

The present invention relates generally to the access of various password-enabled computer network elements through the use of a single password enabled network element.

### OBJECTS & SUMMARY OF THE INVENTION

According to one particularly preferred embodiment of the present invention, a method of accessing a plurality of network elements (NE) is provided with at least one network element management program (NEMP) comprising capturing a username and a password within the network element management program (NEMP); and submitting the captured username and password to each of the plurality of network elements (NE) so as to effect administrative address privileges for each of the plurality of network elements (NE) without re-capturing the username and the password.

In other aspects of the invention, the method further comprises the step of encrypting the username and password within the network element management program (NEMP); or alternatively, further comprises the step of storing the encrypted username and password and decrypting the stored username and password before submitting them to each of the plurality of network elements; or alternatively; the plurality of network elements (NE), the at least one network element management program (NEMP) and the network (NET) are arranged according to the Internet Protocol. In another aspect of these inventions, the method further comprised the step of sending the captured username and password transparently to at least one of the plurality of network elements (NE) via a web browser; or alternatively, the plurality of network elements (NE) and the at least one network element management program (NEMP) are running on Windows Operating System; or alternatively, the method is characterized in that it is placed in the Graphical Identification and Authentication (GINA) component of the Windows Operating System; or alternatively, the method places and stores the encrypted username and password in the registry of the Windows Operating System.

In another particularly preferred embodiment of the present invention, a system of accessing a plurality of network elements is provided comprising at least one element manager (EM) connected to the network elements NE) via a network for capturing a username and a password and for submitting the captured username and password to each of the plurality of network elements (NE) so as to effect administrative address privileges for each of the plurality of network elements without re-capturing the username and the password.

In other aspects of this invention, the system is characterized in that the at least one element manager (EM) comprises an encoder (NEMP) for encrypting the captured username and password; or in that the system may further include a database (DB) coupled to the network element management program (NEMP) for storing the encrypted username and password; or in that the system may further include a decoder (NEMP) for decrypting the stored username and password before submitting them to each of the plurality of network elements (NE).

### BRIEF DESCRIPTION OF THE DRAWINGS

The invention will be further described by way of example, with reference to the accompanying drawings, in which:

FIG. 1 is an exemplary block diagram of a conventional implementation of a network element management system according to one embodiment of the present invention;

FIG. 2 is a simplified Windows Login Overview Diagram according to one embodiment of the present invention;

FIG. 3 is a flow chart representation showing the capturing and storing of username and password from the Windows 2000 login according to one embodiment of the present invention; and

FIG. 4 is a flow chart representation showing the retrieval of the stored username and password by the “Auto Login” routine according to one embodiment of the present invention.

The present invention, and one or more embodiments, shall now be described with reference to the enumerated figures.

### DETAILED DESCRIPTION OF THE PREFERRED EMBODIMENTS

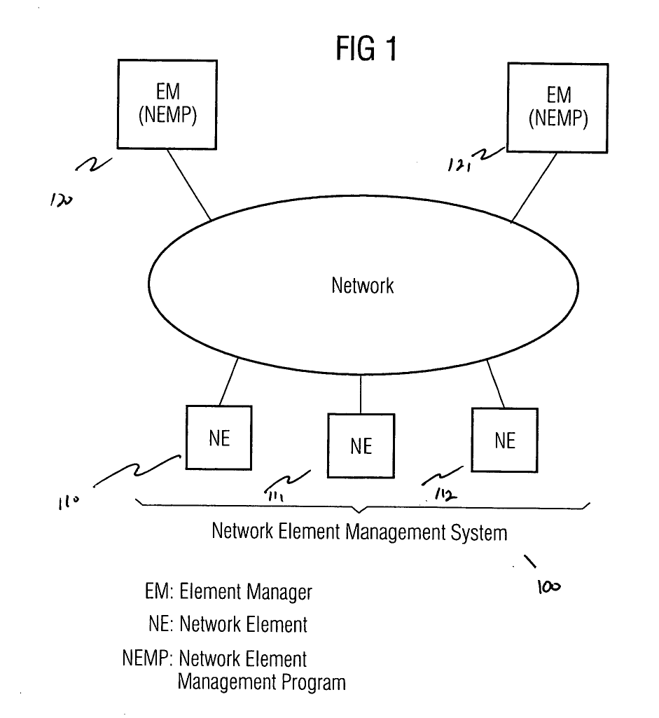

FIG. 1 illustrates a typical problem encountered in a network element management system 100 employed by corporate entities and organizations today. Access to the network elements 110-112 are provided to users via one or more interactive devices (element manager) 120-121 such like computer terminals, workstations, computers which are coupled to a network (e.g. a TCP/IP network) and on which a network element management program is active. The network element supports e.g. SNMP (Simple Network Management Protocol) whereby the network element management program can be running e.g. on a Windows or Unix operating system.

At the present time management of network elements is handled by a management system by simply opening a web browser, which is directed to the network elements IP (Internet Protocol) address. The network element is then managed via a built-in Flash web interface. Since the management system uses the web interface and this interface is secure, the user must enter his username and password each and every time he accesses a different network element.

The security system of the network element is straightforward. The network element houses an internal username/password database containing a limited number of users and their access levels. When a user tries to access a network element a challenge box is presented. The user must then enter his username and password in order to gain access into the network element web interface. This is true regardless of how the user tries to gain access to the network element, i.e. via the network element management system or directly from a web browser.

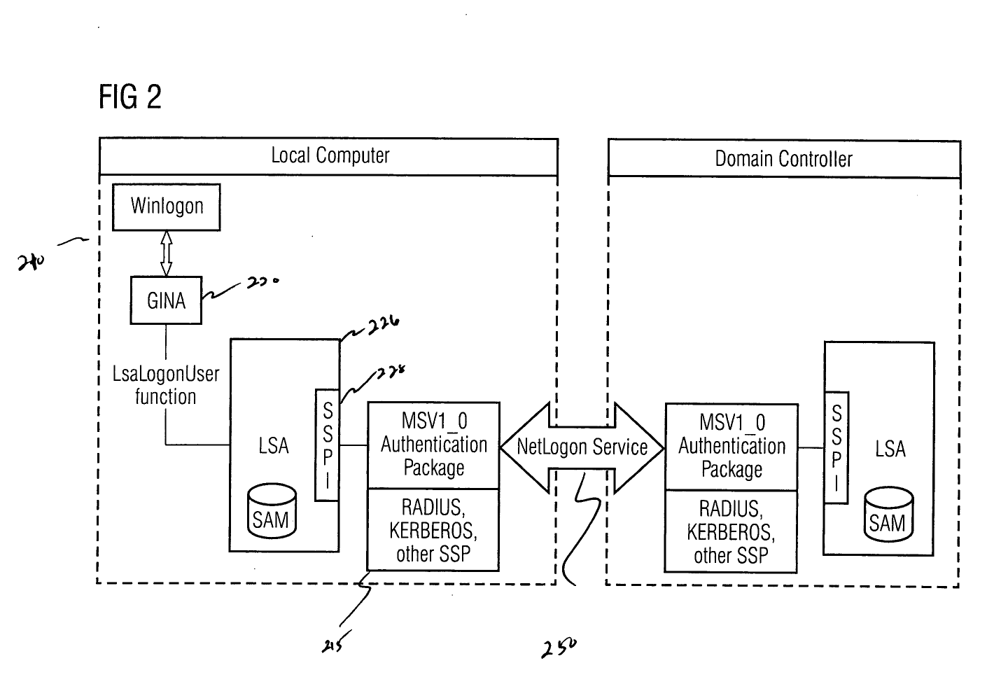

With reference to FIG. 2, when a user logs an to a computer running Windows 2000 Professional or Server 210, the Windows operating system uses two authentication procedures to log the user on locally:

1. Windows attempts to use Kerberos (KDC) 215 as the primary source of user authentication. KDC is a service that runs an all domain controllers and Works with Active Directory and Kerberos security authentication services.

2. If the KDC service is not available when the user logs on to the Computer, Kerberos cannot authenticate the user. Instead Windows uses Windows NT LanManager (NTLM) security to authenticate users in the local Security Accounts Manager (SAM) database. Windows 2000 uses the NTLM security system for compatibility with earlier versions of Windows NT.

Local logon authentication then progresses according to the following steps:

1. The user types his username and password. The Graphical Identification and Authentication (GINA) 220 component collects the users' username and password.

2. GINA passes the secure information to the Local Security Authority (LSA) 226 for authentication.

3. The LSA passes the information to the Security Support Provider Interface (SSPI) 228. SSPI is an interface that communicates to both Kerberos and NTLM services and allows developers to Write security aware applications without knowing Kerberos or NTLM specifics.

4. SSPI passes the username and password to Kerberos SSP (Security Service Package). Kerberos SSP checks to see if the target Computer name is the local Computer or the domain name. Kerberos passes an error message to SSPI if it is the local Computer name. The Computer generates an internal error not visible to the user. The following error message is passed back if the network was checked and no KDC could be found:

### No Logon Server Available

5. The internal error message triggers SSPI to start the process over again with GINA. GINA passes the information to LSA again, and then LSA passes the information to SSPI again.

6. This time, SSPI passes the username and password to the NTLM driver MSV1-0 SSP. The NTLM driver uses the NetLogon service 250 to validate the user against the local SAM database.

7. The user receives the following error message only if both Kerberos and NTLM fail to authenticate the user's account:

Logon Message:

The system could not log you on. Make sure your Username and domain are correct, then type your password again. Letters in passwords must be typed using the correct case. Make sure that Caps Lock is not accidentally on.

This received error message is the same regardless of whether the password is typed incorrectly or the username is not in the local SAM database, for security purposes.

The above mentioned process occurs only once for the user to be able to log on to the Network. However if the user now needs to log on to other, different network elements, which could potentially be numerous, he or she would have to enter the same user name and password at the login prompt at the browser. In essence, each resource is required to independently authenticate the user's identifier and password before entry is granted.

According to the present invention, there is provided a method of accessing a plurality of network elements with at least one network element management program, the method including the steps of capturing a username and a password within the network element management program, and submitting the captured username and password to each of the plurality of network elements so as to effect administrative address privileges for each of the plurality of network elements without re-capturing and/or re-encrypting the username and the password.

In one aspect of the invention this so called “Auto Login” feature in the network element management system is a transparent function to the user. The purpose of the feature is to capture the username and password of the user in order to log the user into individual network elements without having to reenter his username and password. With the Auto Login feature the username and password is automatically sent to the network element by the network element management system whenever the user requests access to a network element. If the user-name/password combination is valid the user is given access; otherwise the user sees a standard “access denied” screen.

The GINA described above as part of the Windows authentication process (located on an element manager) can be replaced in order to develop additional security measures. The main component of the Auto Login feature is in the form of a DLL file (so called Auto Login replacement DLL) that replaces the standard Windows GINA. The Code skeleton for the DLL is part of the MSDN library.

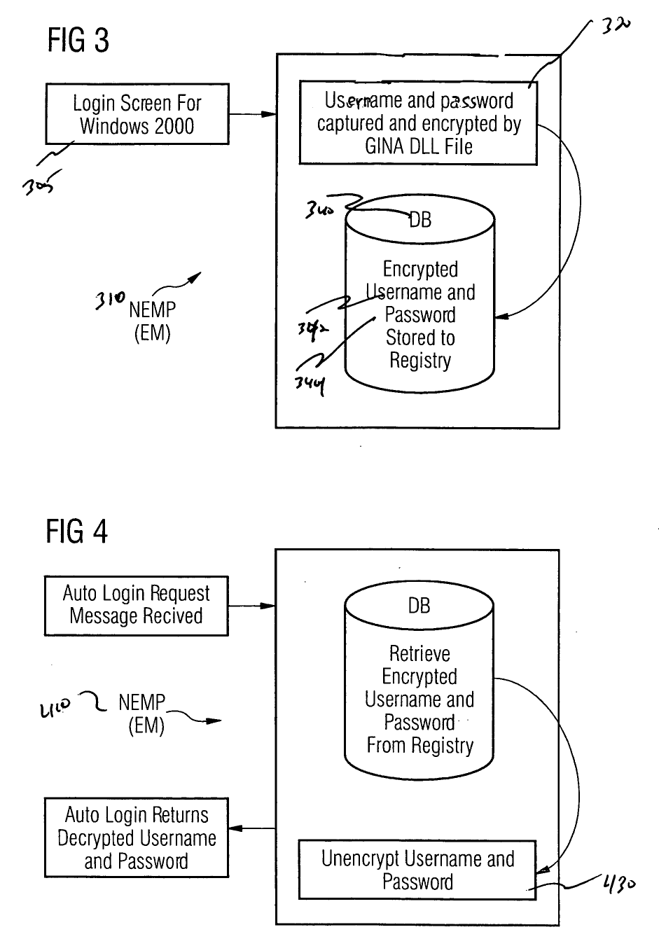

According to FIG. 3 as an example, once properly configured, Windows uses the Auto Login replacement DLL 320 located on the element manager 310 to perform all user authentication from the Windows login screen 305. As part of the replacement DLL Code, the username 342 and password 344 entered by the user are captured and stored in a database DB 340, e.g. in the registry of the Windows operating system located in the element manager as encoded values.

With reference to FIG. 4, the network element management system 410 retrieves, decrypts, and passes these values from the element manager to the network element as needed via a standard HTTP header. The management system also deletes the encoded username and password from the registry. This information could be overwritten when the next user logs into the system.

The new GINA according to the invention shows the same logon screens and provides all the functionality of the original GINA. The user sees no differences. This makes this solution totally transparent to the user.

In this example the current version of Auto Login assumes the client is running on a Windows-based computer. It also assumes the DLL file can be placed onto the client machine in the proper directory (which is c:\winnt\system in most cases) and that the registry and the client machine can be edited by the network element management system.

The following is a list of the functions needed to implement the Auto Login according to the invention in an advanced way:

Initiate Auto Login:

From the users standpoint Auto Login is initiated automatically any time the user selects the “Get Network Element Parameters” menu option from within the network element management system. Mouse-Right clicking on a given network element on the monitor accesses this menu.

Internally subsystems interface with Auto Login by sending a request message to the Auto Login subroutine. The Auto Login subroutine will return the decrypted username and password.

Encrypt/unencrypted username and password:

Auto Login encrypts the username and password entered by the user. The network element management system also uses an unencryption module 340 to unencrypt the username and password before passing them to the web server on the network element.

Store username and Password to registry:

The username and Password captured by Auto Login are stored on the hard drive for later use by the element manager for the management system. This is done by encrypting the username and password and placing them in the registry.

User authorization:

The element manager sends the captured username and Password to any network element the user request to view. It is the responsibility of the network element to authenticate the user and allow of deny access.

The present invention has been described in terms of at least one example. However, nothing in this description shall be considered to limit the invention to any specific embodiment or the features thereof to any limited range of equivalents. Thus the disclosed embodiments and other formulations of the invention shall be readily understood by any one skilled in the art in light of the illuminative description.

1. A method of accessing a plurality of network elements (NE) with at least one network element management program (NEMP) comprising:
capturing a username and a password within said network element management program (NEMP); and
submitting said captured username and password to each of said plurality of network elements (NE) so as to effect administrative address privileges for each of said plurality of network elements (NE) without re-capturing said username and said password.

2. A method as claimed in claim 1, further comprising the step of encrypting said username and password within said network element management program (NEMP).

3. A method as claimed in claim 2, further comprising the step of storing the en-crypted username and password and decrypting the stored username and password before submitting them to each of said plurality of network elements.

4. A method as claimed in claim 1, wherein the plurality of network elements (NE), the at least one network element management program (NEMP) and the network (NET) are arranged according to the Internet Protocol.

5. A method as claimed in claim 4, further comprising the step of sending the captured username and password transparently to at least one of the plurality of network elements (NE) via a web browser.

6. A method as claimed in claim 1, wherein the plurality of network elements (NE) and the at least one network element management program (NEMP) are running on Windows Operating System.

7. A method as claimed in claim 6, characterized in that said method is placed in the Graphical Identification and Authentication (GINA) component of the Windows Operating System.

8. A method as claimed in claim 6 or 7, wherein said encrypted username and password are placed and stored in the registry of said Windows Operating System.

9. A system of accessing a plurality of network elements comprising:
at least one element manager (EM) connected to the network elements NE) via a network for capturing a username and a password and for submitting said captured username and password to each of said plurality of network elements (NE) so as to permit administrative address privileges for each of said plurality of network elements without re-capturing said username and said password.

10. A system as claimed in claim 9, characterized in that said at least one element manager (EM) comprises an encoder (NEMP) for encrypting said captured username and password.

11. A system as claimed in claim 10, further comprising a database (DB) coupled to the network element management program (NEMP) for storing the encrypted username and password.

12. A system as claimed in claim 11, further comprising a decoder (NEMP) for decrypting the stored username and password before submitting them to each of said plurality of network elements (NE).
